(19) United States
(12) Patent Application Publication
(10) Pub. No.: US 2026/0233299 A1
(43) Pub. Date: Aug. 13, 2026

(54) METHODS OF PRESERVING METAL NANOPHASE PHYSICOCHEMICAL SURFACE PROPERTIES THROUGH CHEMICAL MODIFICATION

(71) Applicant: University of Central Florida Research Foundation, Inc., Orlando, FL (US)

(72) Inventors: Craig Neal, Orlando, FL (US); Elayaraja Kolanthai, Orlando, FL (US); Sudipta Seal, Orlando, FL (US)

(73) Assignee: University of Central Florida Research Foundation, Inc., Orlando, FL (US)

(21) Appl. No.: 19/536,775

(22) Filed: Feb. 11, 2026

Related U.S. Application Data
(60) Provisional application No. 63/757,350, filed on Feb. 12, 2025.

(51) Int. Cl. B22F 1/00; B22F 1/054; B22F 1/102

(52) U.S. Cl. CPC B22F 1/00; B22F 1/054; B22F 1/102

(57) ABSTRACT

The present disclosure provides methods of preserving physicochemical surface properties of metallic nanophase materials exposed to environmental agents. The methods comprise chemically modifying the metallic nanophase material with a molecular species having a stronger chemical affinity for a metal component of the metallic nanophase material than a chemical affinity of the environmental agent for the metal component. The metallic nanophase material may comprise silver-containing nanomaterials, such as silver-cerium oxide biphasic nanomaterial compositions or silver-modified cerium oxide nanoparticles. The molecular species may be a thiol-containing organic species, such as beta-mercaptoethanol, which may be adsorbed on the surface of the metallic nanophase material via thiol-metal bonding. The methods may protect the metallic nanophase material from oxidation by environmental oxidizing agents, such as amino acids including cysteine. The molecular species may form a film on the surface that prevents oxidant diffusion. The chemical modification may include pre-incubation of the metallic nanophase material in an aqueous solution containing the molecular species.

### FIELD OF THE INVENTION

The present disclosure relates to methods of preserving physicochemical surface properties of metallic nanophase materials, and more particularly to methods of chemically modifying metallic nanophase materials with molecular species to protect against environmental agents.

### BACKGROUND

Metallic and metal-based nanomaterials have been incorporated as functional components in a broad range of enabling technologies across various industries. Non-limiting examples include metal nanoparticles and metal nano-domains of multi-component nanoparticle formulations, such as silver-modified cerium oxide nanoparticles.

In many instances, material performance may be related to physicochemical processes involving the material surface. For example, nanoscale metallic quantum dots may possess optical properties informed by their generation of surface plasmons. Additionally, chemical reactions in various industries, including petroleum, fine chemicals, and medical applications, may rely on reactant adsorption to metal domains, charge transfer, and release of valuable chemical products. Adsorption of molecular species can permit charge transfer and chemical transformations with or without photoexcitation by absorption of electromagnetic energy. Similarly, metal-based domains may allow imaging through photoemissions and excitation of surface plasmon resonances.

These properties have proved valuable in the biomedical industry where nanomaterials may be used in commercial products or as components in devices. Noble metal nanomaterials, such as silver or gold, are among compositions that have been approved by regulatory agencies for use in commercial products. However, such materials may be susceptible to inactivation by chemical species associated with their application environments.

In some cases, irreversible modification of the material surface through interactions with certain biomolecules in application environments may lead to modulation or complete inactivation of these physicochemical processes. For example, oxidation of silver in the presence of certain amino acids has been observed, which may lead to reduction in material performance.

There therefore exists a need for improved ways of preserving metal nanophase physicochemical surface properties.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method of preserving physicochemical surface properties of a metallic nanophase material exposed to an environmental agent is provided. The method comprises chemically modifying the metallic nanophase material with a molecular species having a stronger chemical affinity for a metal component of the metallic nanophase material than a chemical affinity of the environmental agent for the metal component.

According to other aspects of the present disclosure, the method may include one or more of the following features. The chemical modification may include pre-incubation of the metallic nanophase material. The pre-incubation may include exposing the metallic nanophase material to a solution containing the molecular species. The metallic nanophase material may comprise a silver-containing nanomaterial. The metallic nanophase material may comprise a silver-cerium oxide biphasic nanomaterial composition. The solution may be an aqueous solution. The molecular species may be a thiol-containing organic species. The molecular species may be beta-mercaptoethanol. The environmental agent may comprise an amino acid. The amino acid may be cysteine.

According to another aspect of the present disclosure, a method of protecting a metallic nanophase material from oxidation by an environmental oxidizing agent is provided. The method comprises contacting the metallic nanophase material with a ligand species that binds to a metal component of the metallic nanophase material.

According to other aspects of the present disclosure, the method may include one or more of the following features. The ligand species may bind to the metal component with a binding strength greater than a binding strength of the environmental oxidizing agent to the metal component. The metallic nanophase material may comprise noble metal nano-domains. The noble metal nano-domains may comprise silver, gold, or platinum. The ligand species may comprise a thiol group. The contacting may be performed at room temperature.

According to another aspect of the present disclosure, a method of preparing a surface-modified metallic nanophase material is provided. The method comprises adsorbing a molecular species on a surface of a metallic nanophase material, wherein the molecular species has a chemical affinity for a metal component of the metallic nanophase material greater than a chemical affinity of an environmental agent for the metal component.

According to other aspects of the present disclosure, the method may include one or more of the following features. The molecular species may form a film on the surface that prevents oxidant diffusion. The metallic nanophase material may comprise silver-modified cerium oxide nanoparticles. The molecular species may comprise beta-mercaptoethanol bonded to the surface via a thiol-silver bond.

The foregoing general description of the illustrative embodiments and the following detailed description thereof are merely exemplary aspects of the teachings of this disclosure and are not restrictive.

### BRIEF DESCRIPTION OF THE DRAWINGS

A more complete understanding of the present invention, and the attendant advantages and features thereof, will be more readily understood by reference to the following description when considered in conjunction with the accompanying drawings wherein:

FIG. 1 is a series of photographs showing the protection of silver from cysteine-mediated oxidation by β-mercaptoethanol modification, according to aspects of the present disclosure.

FIG. 2 shows spectrophotometry measurements evidencing β-Mercaptoethanol complexation with silver-modified cerium oxide nanoparticles, according to aspects of the present disclosure.

### DETAILED DESCRIPTION

As required, embodiments are disclosed herein; however, it is to be understood that the disclosed embodiments are merely examples and that the devices and methods described below can be embodied in various forms. Therefore, specific structural and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

It can be advantageous to set forth definitions of certain words and phrases used throughout this disclosure. The terms “a” or “an”, as used herein, are employed to describe elements and components described herein. This is done merely for convenience and to give a general sense of the scope of the disclosure. This description should be read to include one or at least one and the singular also includes the plural unless it is obvious that it is meant otherwise. The term plurality, as used herein, is defined as two or more than two. The term another, as used herein, is defined as at least a second or more. The term “coupled,” as used herein, is defined as “connected,” although not necessarily directly, and not necessarily mechanically.

The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A; B; C; A and B; A and C; B and C; and A, B, and C.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Note that not all of the activities described in the general description or the examples are required, that a portion of a specific activity may not be required, and that one or more further activities can be performed in addition to those described. Still further, the order in which activities are listed are not necessarily the order in which they are performed.

The present disclosure relates generally to methods of preserving metal nanophase physicochemical surface properties through chemical modification of metallic and metal-based nanomaterials to preserve physicochemical surface properties in biological and biomedical application environments. In some aspects, the methods described herein may provide improved technological lifetimes for metallic nanophase materials exposed to environmental agents that would otherwise cause inactivation or degradation of material performance.

In some aspects, the method may involve pre-incubation of silver-nanophases in silver-cerium oxide biphasic nanomaterial compositions with molecular species showing stronger chemical affinities for silver. By this approach, the silver phase, which may be sensitive to oxidation via biomolecular species such as cysteine or chemical etching, may be protected against adsorption of undesired chemical species. In some cases, choice of surface modifier may permit permeation of desired solution-dispersed species for chemical transformations at the silver surface, such as the shorter chain beta-mercaptoethanol molecule.

As used herein, the term “pre-incubation” may refer to a process wherein a relevant particle formulation is first exposed to a solution of beta-mercaptoethanol (or another chosen surface modifier) prior to particle incubation in or exposure to biological solutions containing oxidizing agents such as cysteine. This term may be replaced by “pre-treatment with,” “adsorption of,” “modification with,” or “coating with” beta-mercaptoethanol, without loss of meaning.

In some aspects, metallic and metal-based nanomaterial phases may be protected from inactivation by chemical components (solvent-dispersed, gaseous/vapors, solids) from application environments through surface modification by molecular species. One specific example where the methods of the present disclosure may be useful is silver-modified cerium oxide nanoparticles, which have been shown in research literature to act as antimicrobial agents. The observed activity has been ascribed largely to nanomaterial surface redox reactions. The oxidation of silver in the presence of the amino acid cysteine has also been observed, which may lead to reduction in material performance.

In some aspects, pre-incubation of the material in an aqueous solution containing beta-mercaptoethanol may produce a protective effect against oxidation upon subsequent exposure to cysteine. Surface modification of susceptible metallic/metal-based phases, such as silver nanodomains, by adsorption of higher chemical affinity molecules (e.g., thiol-containing organic species binding to noble metal phases) may confer similar protection and increase the technological lifetimes of these materials.

The surface modification may be particularly useful in biochemical environments containing high salt concentrations, redox molecules, and dissolved oxygen at moderate temperatures.

In some aspects, coating the surface of noble metal (silver) nano-domains with a ligand species, bound with moderate strength, may prevent silver interaction with environmental oxidants. Beta-mercaptoethanol may accomplish this function through thiol-silver bonding at one end of the short chain molecules, and may allow continued dispersibility (colloidal stability, suspension) in aqueous media by exposing its alcohol-OH functional group to the suspension/solution environment.

In some cases, the ability to form somewhat dense films/coatings of this molecule may prevent oxidant diffusion to bare surface sites.

In some aspects, adsorption of beta-mercaptoethanol on silver may be spontaneous at room temperature. Therefore, mixing an aqueous solution of beta-mercaptoethanol and an aqueous suspension of silver-modified cerium oxide nanoparticles at room temperature may be sufficient to allow adsorption.

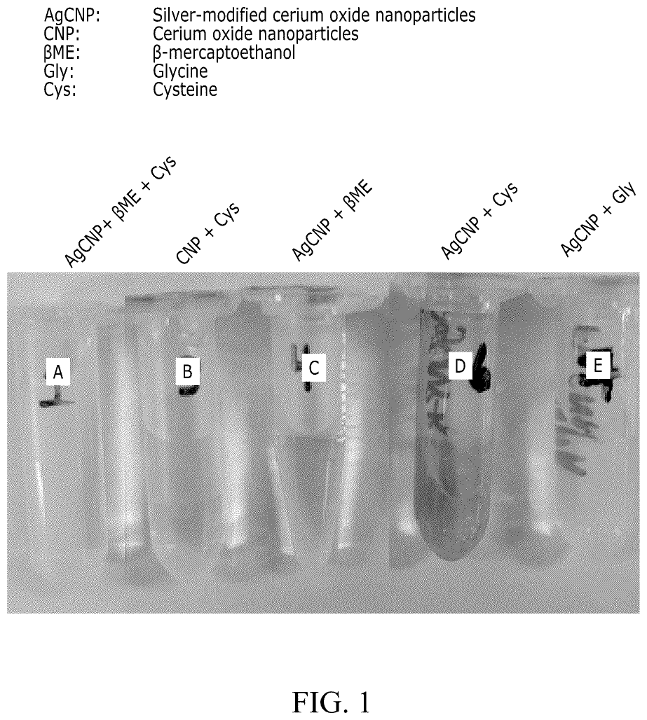

Referring to FIG. 1, a series of photographs showing protection of silver from cysteine-mediated oxidation by beta-mercaptoethanol modification is presented. Oxidation may be evidenced in sample D wherein brown coloration has been ascribed to silver oxidation upon addition of cysteine to a dispersion of silver-modified cerium oxide nanoparticles (AgCNPs). Comparison against sample A shows that pre-incubation of AgCNPs in a solution containing beta-mercaptoethanol may prevent the oxidation of AgCNP-associated silver, as evidenced from the absence of brown coloration. Samples B, C, and E are presented as control samples.

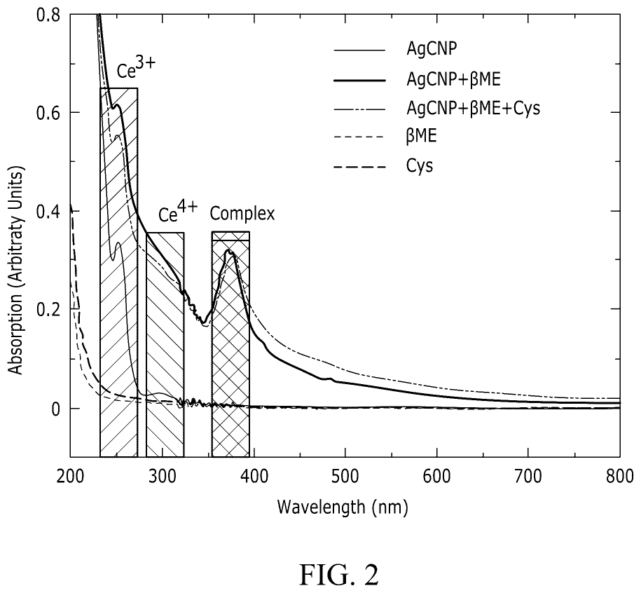

Referring to FIG. 2, spectrophotometry measurements evidencing beta-mercaptoethanol complexation with silver-modified cerium oxide nanoparticles are shown. UV-Vis spectrophotometry measurements may confirm specific interaction between silver-modified cerium oxide nanoparticles as an additional chemical complex peak. Control AgCNP, beta-mercaptoethanol, and cysteine solutions may possess no measurable absorbance at wavelengths greater than 350 nm. Peaks associated with Ce4+ and Ce3+ may retain their peak characters, suggesting beta-mercaptoethanol interaction does not appreciably affect cerium oxide surface character.

In some aspects, spontaneity of adsorption may make the process simple and without many process variables that would need controlling. However, in some cases, temperature may be reduced to increase density of surface coverage/film by reducing thermal motion of aqueous and surface adsorbed ligands. Additionally, a post-treatment procedure may be incorporated (e.g., dialysis) to remove unbonded (free or solution-dispersed) ligand species.

Although silver is used as a non-limiting example, other noble metal nano-phases may be used such as gold or platinum which have chemical affinities for thiol-/mercapto-groups on ligand species.

In some aspects, ligand composition may be varied to suit specific applications. For example, for a chain-like organic ligand, the solution-interfacing end group may be varied based on preference for polarity/charge or hydrophilicity. The chain region may be varied to prevent/promote film density or other steric considerations.

All references cited herein are expressly incorporated by reference in their entirety. It will be appreciated by persons skilled in the art that the invention is not limited to what has been particularly shown and described herein above. In addition, unless mention was made above to the contrary, it should be noted that all of the accompanying drawings are not to scale. There are many different features to the invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the invention set forth herein that are within the scope and spirit of the present invention are to be included as further embodiments of the invention.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the disclosure, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

The above discussion is meant to be illustrative of the principles and various embodiments of the present invention. Numerous variations and modifications will become apparent to those skilled in the art once the above disclosure is fully appreciated.

1. A method of preserving physicochemical surface properties of a metallic nanophase material exposed to an environmental agent, the method comprising:
chemically modifying the metallic nanophase material with a molecular species having a stronger chemical affinity for a metal component of the metallic nanophase material than a chemical affinity of the environmental agent for the metal component.

2. The method of claim 1, wherein the chemical modification includes pre-incubation of the metallic nanophase material.

3. The method of claim 2, wherein the pre-incubation includes exposing the metallic nanophase material to a solution containing the molecular species.

4. The method of claim 1, wherein the metallic nanophase material comprises a silver-containing nanomaterial.

5. The method of claim 4, wherein the metallic nanophase material comprises a silver-cerium oxide biphasic nanomaterial composition.

6. The method of claim 3, wherein the solution is an aqueous solution.

7. The method of claim 1, wherein the molecular species is a thiol-containing organic species.

8. The method of claim 7, wherein the molecular species is beta-mercaptoethanol.

9. The method of claim 1, wherein the environmental agent comprises an amino acid.

10. The method of claim 9, wherein the amino acid is cysteine.

11. A method of protecting a metallic nanophase material from oxidation by an environmental oxidizing agent, the method comprising:
contacting the metallic nanophase material with a ligand species that binds to a metal component of the metallic nanophase material.

12. The method of claim 11, wherein the ligand species binds to the metal component with a binding strength greater than a binding strength of the environmental oxidizing agent to the metal component.

13. The method of claim 11, wherein the metallic nanophase material comprises noble metal nano-domains.

14. The method of claim 13, wherein the noble metal nano-domains comprise silver, gold, or platinum.

15. The method of claim 11, wherein the ligand species comprises a thiol group.

16. The method of claim 11, wherein the contacting is performed at room temperature.

17. A method of preparing a surface-modified metallic nanophase material, the method comprising:
adsorbing a molecular species on a surface of a metallic nanophase material, wherein the molecular species has a chemical affinity for a metal component of the metallic nanophase material greater than a chemical affinity of an environmental agent for the metal component.

18. The method of claim 17, wherein the molecular species forms a film on the surface that prevents oxidant diffusion.

19. The method of claim 17, wherein the metallic nanophase material comprises silver-modified cerium oxide nanoparticles.

20. The method of claim 17, wherein the molecular species comprises beta-mercaptoethanol bonded to the surface via a thiol-silver bond.
